(19) United States
(12) Patent Application Publication
(10) Pub. No.: US 2021/0324882 A1
(43) Pub. Date: Oct. 21, 2021

(54) ROD-LESS CYLINDER WITH TWO PISTONS

(71) Applicant: URAKAMI LLC, Kanagawa (JP)

(72) Inventor: Fukashi URAKAMI, Kanagawa (JP)

(21) Appl. No.: 17/359,885

(22) Filed: Jun. 28, 2021

Related U.S. Application Data
(63) Continuation of application No. PCT/JP2019/048164, filed on Dec. 9, 2019.

(30) Foreign Application Priority Data
Dec. 30, 2018 (JP) 2018-248810

(51) Int. Cl. F15B 15/14

(52) U.S. Cl. CPC F15B 15/1447; F15B 15/1433; F15B 15/1409

(57) ABSTRACT

In the present invention, both ends of a cylinder are blocked by end caps, two pistons that reciprocate within the cylinder due to fluid pressure are disposed inside the cylinder, and a space surrounded by the two pistons and the inner wall of the cylinder is connected to a fluid supply/exhaust port provided an end cap of the cylinder via a coiling tube position inside the cylinder.

### CROSS-REFERENCE TO RELATED APPLICATIONS

This is a continuation application of a prior PCT application No. PCT/JP/2019/048164 filed on Dec. 9, 2019.

### TECHNICAL FIELD

The present invention relates to a rod-less cylinder having two pistons, and more particularly to a rod-less cylinder having a function capable of changing a distance between a piston and a piston at an arbitrary time and at an arbitrary distance.

### BACKGROUND ART

Conventionally, a rod-less cylinder with two pistons is commercially available, but does not have a function of optionally changing the distance between the piston and the piston at any time and at any distance.

No patent literature relating to a rod-less cylinder having two pistons is not present.

### SUMMARY OF THE INVENTION

The commercially available rod-less cylinders, which are simply composed of two pistons, are not equipped with a means to change the distance between the pistons at any given time and at any given distance.

However, in many moving devices, especially in robotic devices, a rod-less cylinder is desired that is compact, has a light weight, and the distance between each piston is freely adjustable.

The present invention proposes a rod-less cylinder having a control means capable of changing a distance between a piston and a piston at an arbitrary time and at an arbitrary distance.

Hereinafter, a means for achieving the above-mentioned problems will be described.

Describing an embodiment of a rod-less cylinder of the present invention capable of achieving the above task, each of the two ends of the cylinder is sealed with an end cap, and two pistons that reciprocate within the cylinder by fluid pressure are disposed inside said cylinder.

Furthermore, the space enclosed by the two pistons and the inner wall of the cylinder is connected to a port for fluid supply and exhaust provided in one end cap via coiling tubes disposed in the cylinder.

Describing another embodiment of the invention that can achieve the above problem, the cylinder is provided with a slit, each of the two ends of the cylinder is blocked with an end cap, and two pistons that reciprocate and move inside the cylinder by fluid pressure are disposed inside the cylinder.

A part of the member constituting each piston is connected to a slider located outside the cylinder after penetrating the slit, i.e., the piston and the slider are integrated via the penetrating member. The space enclosed by the two pistons and the inner wall of the cylinder is connected to a port for fluid supply and exhaust located on one end cap via a coiling tube located inside the cylinder.

The rod-less cylinder with the two pistons according to the present invention improves the ability of the rod-less cylinder by allowing the distance between the piston and the piston to be freely changed.

Compared to a device constructed by combining two commercially available rod-less cylinders with one piston, the rod-less cylinder of the present invention can be one-half of the mass and volume of the rod-less cylinder itself, and the manufacturing cost can also be greatly reduced.

Therefore, the rod-less cylinder provided with the two pistons according to the present invention can be reduced in weight, compact in shape, and reduced in manufacturing cost as compared with a conventional rod-less cylinder.

### BRIEF DESCRIPTION OF THE DRAWINGS

FIG. 1 is a cross-sectional view taken along a line B-B in the apparatus shown in FIG. 2, and showing a device configuration of a preferred embodiment of the apparatus constructed in accordance with the present invention.

FIG. 2 is a cross-sectional view taken along line A-A in the apparatus shown in FIG. 1.

FIG. 3 is a view showing three aspects of supplying compressed air to the apparatus shown in FIG. 1 and FIG. 2.

### DETAILED DESCRIPTIONS OF THE PREFERRED EMBODIMENTS

A preferred embodiment of the apparatus constructed in accordance with the present invention will now be described with reference to the accompanying drawings.

A preferred embodiment of the apparatus constructed in accordance with the present invention will now be described with reference to the accompanying drawings.

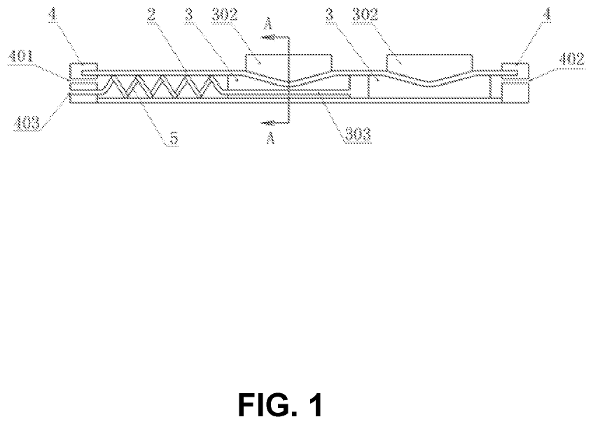

FIG. 1 shows a rod-less cylinder with two pistons according to the present invention. The rod-less cylinder according to the present invention comprises a cylinder 2, two pistons 3, two end caps 4, and a coiling tube 5.

The two pistons 3 may include through-holes 303.

One of the two pistons 3 may be provided with a through-hole 303, and the other may have no through-hole.

The end cap 4 is provided with an intermediate fluid supply/exhaust port 403 for air supply and exhaust, and a left fluid supply/exhaust port 401 and a right fluid supply/exhaust port 402 are provided.

The coiling tube 5 may be configured such that one end thereof is connected to the intermediate fluid supply/exhaust port 403, the other end is connected to the piston through-hole 303, and fluid such as compressed air from the intermediate fluid supply/exhaust port 403 can reach a space surrounded by the two pistons 3 and the inner wall of the cylinder 2.

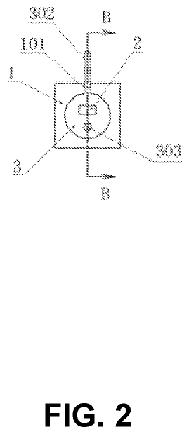

As shown in FIG. 2, both ends of a cylinder 2 are blocked by end caps 4, and two pistons 3 that reciprocate within the cylinder by fluid pressure such as compressed air are disposed inside the cylinder 2.

A part of a member of the pistons 3—a through member of the piston 3—is connected to a slider 302 disposed outside the cylinder 2 through the slit 101, i.e., the pistons and the slider are integrated via the through member.

The space enclosed by the two pistons 3 and the inner wall of the cylinder 2 is connected to the intermediate fluid supply/exhaust port 403 provided in one end cap 4 via the piston through hole 303 and the coiling tube 5.

As described below another preferred embodiment of the rod-less cylinder—not shown in figure, the rod-less cylinder has two pistons 3 each of which has the piston through holes 303 and each of the end caps has the intermediate fluid supply/exhaust ports 403.

Each of the intermediate fluid supply/exhaust ports 403 is connected to the space enclosed by the two pistons 3 and the inner wall of the cylinder 2 via the coiling tube 5.

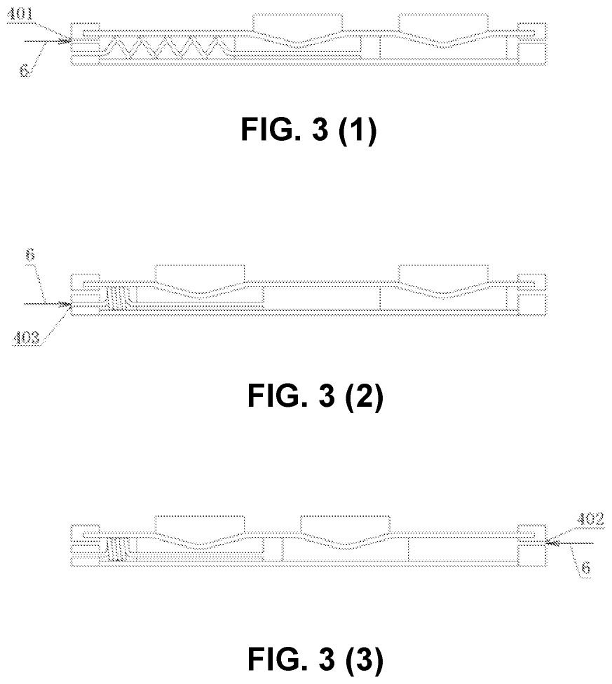

The operation of the above-described apparatus will be described below with reference to FIG. 3.

As shown in FIG. 3, the rod-less cylinder further includes a left fluid supply/exhaust port 401 which is provided at left end cap of the cylinder and a right fluid supply/exhaust port 402 which is provided at right end cap of the cylinder.

According to one embodiment of the present invention, In FIG. 3(1), when compressed air is supplied to the left fluid supply/exhaust port 401, the compressed air passes through the coiling tube 5 and the piston through-hole 303 to reach the space surrounded by the two pistons 3 and the inner wall of the cylinder 2, and as shown in FIG. 3(2), the compressed air acts on the pistons 3 respectively, causing the two pistons 3 to move away from each other and the distance between the two pistons 3 to increase.

In FIG. 3(3), when compressed air is supplied to the right fluid supply/exhaust port 402, the compressed air acts on the right piston 3 to move it to the left in the figure. At this time, the compressed air in the space enclosed by the two pistons and the inner wall of the cylinder 2 is exhausted out of the device through the through-piston hole 303, the coiling tube 5, and the left fluid supply/exhaust port 401.

The effect of the apparatus of the preferred embodiment constructed in accordance with the present invention will be described.

The rod-less cylinder having two pistons according to the present invention can freely control the distance between the piston and the piston, that is, it is possible to change the distance to an arbitrary distance at any time, thereby improving the ability of the rod-less cylinder to move.

The slit-type rod-less cylinder according to the present invention described above is an example of a rod-less cylinder, and the present invention may be a magnet-type rod-less cylinder for operating the slider by utilizing the action of magnetic force by the piston.

While a preferred embodiment has been described with respect to a rod-less cylinder having two pistons according to the present invention, various modifications or variations are possible without departing from the scope of the invention, and various embodiments may be considered in accordance with the appended claims, in addition to the preferred embodiments.

The rod-less cylinder equipped with the two pistons according to the present invention is reduced in weight, compact in volume, reduced in manufacturing cost, and can be advantageously used for various applications as compared with a rod-less cylinder configured by simply combining two commercially available pistons.

What is claimed is:

1. A rod-less cylinder with two pistons, comprising:
both ends of the cylinder are blocked by end caps, and two pistons that reciprocate inside the cylinder by fluid pressure are placed inside the cylinder,
a space enclosed by the two pistons and the inner wall of the cylinder is connected to a port for fluid supply and exhaust provided on the end cap of the cylinder via coiling tube placed inside the cylinder.

2. A rod-less cylinder with two pistons, comprising:
a cylinder with a slit, both ends of which are blocked by end caps, has two pistons inside the cylinder that reciprocate inside the cylinder by fluid pressure, and
a part of the members of the pistons is connected to a slider located outside the cylinder through the slit, and the space enclosed by the two pistons and the inner wall of the cylinder is connected to a port for fluid supply and exhaust provided on the end cap of the cylinder via coiling tube placed inside the cylinder.

3. The rod-less cylinder with two pistons according to claim 1, wherein the port for fluid supply and exhaust provided at the end cap at the other end of the cylinder is not directly connected to the space.

4. The rod-less cylinder with two pistons according to claim 2, wherein the port for fluid supply and exhaust provided at the end cap at the other end of the cylinder is not directly connected to the space.

5. The rod-less cylinder with two pistons according to claim 1, wherein the port for fluid supply and exhaust provided at the end cap at the other end of the cylinder is connected to the space via coiling tube placed inside the cylinder.

6. The rod-less cylinder with two pistons according to claim 2, wherein the port for fluid supply and exhaust provided at the end cap at the other end of the cylinder is connected to the space via coiling tube placed inside the cylinder.
